(19) United States
(12) Patent Application Publication
(10) Pub. No.: US 2006/0029151 A1
(43) Pub. Date: Feb. 9, 2006

(54) Capacitive data link

(76) Inventors: Robert D. Moran, King George, VA (US); Cesar A. Ventura, Waldorf, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/067,744

(22) Filed: Mar. 1, 2005

Related U.S. Application Data
(60) Provisional application No. 60/598,895, filed on Aug. 5, 2004.

(51) Int. Cl. H04L 27/10

(52) U.S. Cl. 375/272

(57) ABSTRACT

A capacitive data link includes a first capacitive element. A signal producing entity may be operatively coupled to the first capacitive element and configured to apply an information-carrying electrical signal to the first capacitive element. A second capacitive element may be spaced apart from the first capacitive element and configured to experience a change in charge in response to the information-carrying electrical signal applied to the first capacitive element. The first capacitive element and the second capacitive element may be configured to move relative to one another.

### CLAIM FOR PRIORITY

This application claims the benefit of U.S. Provisional Application No. 60/598,895, filed Aug. 5, 2004, which is incorporated herein by reference.

### TECHNICAL FIELD

The disclosed methods and systems relate generally to the field of information transfer and, more particularly, to the area of information transfer via a capacitively coupled data link.

### BACKGROUND

In many types of systems, it may be desirable to transfer information in the form of electrical signals from a transmission point to one or more receiving points. In certain applications the transmission point may be moving relative to the one or more receiving points. Thus, direct, wired connections between the transmitting point and the receiving points may be impractical.

As an illustrative example, a projectile deployed from a cannon or gun may spin at a relatively high roll rate during flight. For example, this spin rate may be 200 Hz to 300 Hz or above. In certain applications, it may be desirable to decouple the fuze section from the rest of the projectile body using a bearing arrangement. Decoupling the fuze section from the projectile body, however, can render difficult or impossible the use of wired circuitry to transfer information from the fuze section of the projectile to the body section. Similar design challenges may exist in various other applications (e.g., automotive systems, heavy machinery systems, measurement systems, computer systems, aerospace systems, etc.) that include data transfer components in relative motion.

Several information transmitting systems have been proposed that may be useful for transmitting information between two points in relative motion. For example, information may be transferred over a radio frequency (RF) link using modulated electrical signals that are broadcast by a transmitter and received and demodulated with a receiving unit associated with a receiving antenna. Additionally, information may be transferred using optical devices that relay signals in the form of pulsed light.

These systems, however, may be inappropriate for certain applications. For example, these systems may include complex electronic circuitry to modulate, transmit, receive, and demodulate electrical signals. This circuitry may be too large to use in applications where space is limited. Additionally, these systems may experience signal degradation and/or other transmission difficulties associated with the processes of broadcasting a signal and receiving the signal with an antenna. Further, various elements of these systems (e.g., optical components) may lack the structural integrity to withstand mechanical stresses.

The present capacitive link for data transmission is directed toward overcoming one or more of the problems described above.

### SUMMARY OF THE INVENTION

One aspect of the disclosure includes a capacitive data link that includes a first capacitive element. A signal producing entity may be operatively coupled to the first capacitive element and configured to apply an information-carrying electrical signal to the first capacitive element. A second capacitive element may be spaced apart from the first capacitive element and configured to experience a change in charge in response to the information-carrying electrical signal applied to the first capacitive element. The first capacitive element and the second capacitive element may be configured to move relative to one another.

Another aspect of the disclosure includes a method of transferring data from a first component to a second component configured to move relative to the first component. The method may include generating a first information-carrying signal and applying the first information-carrying signal to a first capacitive element coupled to the first component. A change in charge may be observed on a second capacitive element that is coupled to the second component and spaced apart from the first capacitive element. The method may further include generating a second information-carrying signal based on the change in charge observed on the second capacitive element.

Yet another aspect of the disclosure may include a data transmission system that includes a first component and a second component configured to move relative to the first component. At least one electronic device may be operatively coupled to the first component and configured to generate an information-carrying signal. A first capacitive element may be operatively coupled to the first component and configured to receive the information-carrying signal, and a second capacitive element may be operatively coupled to the second component such that the second capacitive element can move relative to the first capacitive element. The second capacitive element may be spaced apart from the first capacitive element and configured to experience a change in charge in response to the information-carrying signal received by the first capacitive element.

### BRIEF DESCRIPTION OF THE DRAWINGS

FIG. 1 provides a diagrammatic illustration of a data transmission system according to an exemplary disclosed embodiment.

FIG. 2 is a block level diagram of a capacitively coupled data link according to an exemplary disclosed embodiment.

FIGS. 3A and 3B provide a diagrammatic illustrations of capacitive elements according to an exemplary disclosed embodiment.

### DETAILED DESCRIPTION

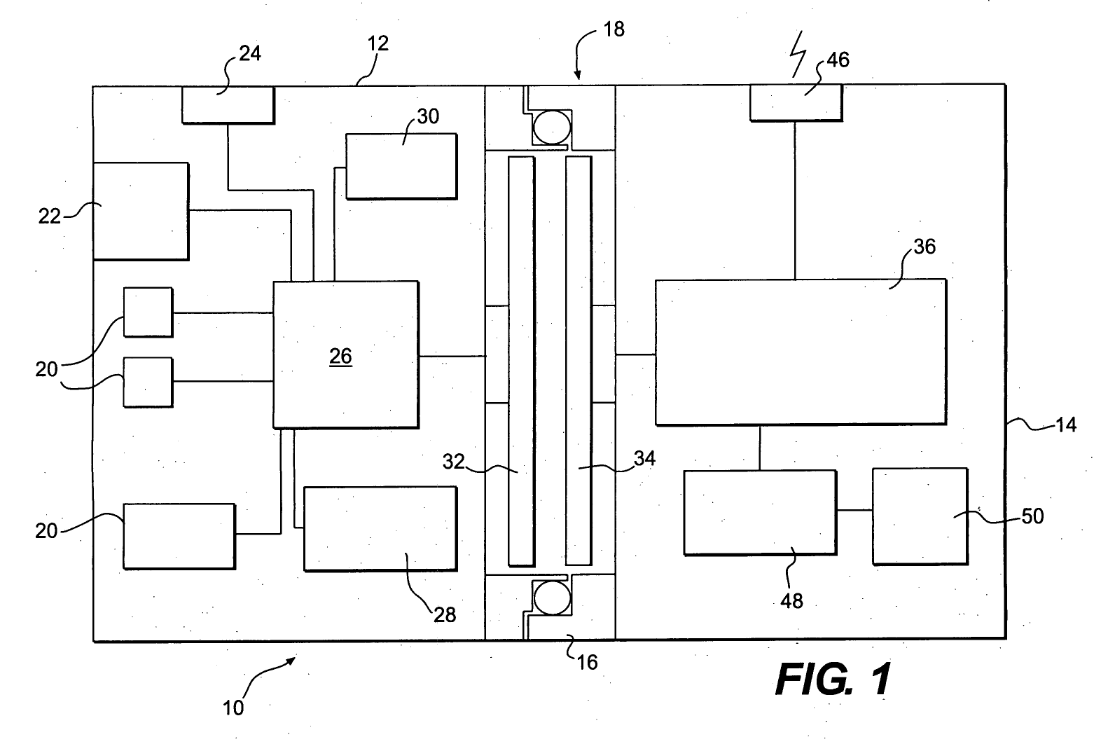

FIG. 1 provides a diagrammatic illustration of a data transmission system 10. Data transmission system 10 may include a data sending unit 12 and a data receiving unit 14. In one embodiment, data sending unit 12 may be operatively coupled to data receiving unit 14 through a bearing 16, which may enable relative motion between data sending unit 12 and data receiving unit 14. Data, in the form of one or more information-carrying electrical signals, may be transferred from data sending unit 12 to data receiving unit 14 via a capacitive data link 18.

Data sending unit 12 may include any number of information gathering and/or information processing devices. For example, data sending unit 12 may include one or more sensors 20 configured to provide output signals in response to an observed quantity. Sensors 20 may include any types of measurement devices suited to a particular application. Sensors 20 may include accelerometers, magnetometers, temperature sensors, light sensors, spin or rotation rate sensors, acoustic sensors, pressure sensors, speed sensors, and/or any other type of sensing device. Data sending unit 12 may also be configured with other information-collecting devices. In one embodiment, data sending unit 12 may include at least one GPS receiver 22 for supplying position information received from satellites associated with the Global Positioning System. Additionally, or alternatively, data sending unit 12 may include a transceiver 24 configured to transmit and/or receive information to or from a location remote from data sending unit 12.

Data sending unit 12 may include a controller 26 configured to receive information from various components associated with data sending unit 12. For example, controller 26 may receive signals from sensors 20, GPS receiver 22, and/or transceiver 24. Controller 26 may process the received signals and provide an output data stream in the form of an information-carrying electrical signal for transfer to another location (e.g., data receiving unit 24). While in one embodiment controller 26 may include one or more processing devices (e.g., digital signal processors), it should be noted that controller 26 may include any types of devices capable of providing an information-carrying electrical signal based on one or more input signals.

Controller 26 may assemble and operate on the information represented by the received signals using any appropriate signal processing techniques. Further, the assembled information may be encoded. That is, at least a portion of the information-carrying electrical signal supplied by controller 26 may be encoded using one or more of frequency shift keying, non-return-to-zero, Manchester encoding, and phase shift keying.

Any of the signals associated with data sending unit 12, including output signals from sensors 20, GPS receiver 22, transceiver 24, the information-carrying electrical signal provided by controller 26, and/or any other signal may include either digital or analog signals. Further, these signals may be supplied at any appropriate amplitude and frequency. In one exemplary embodiment, the information-carrying electrical signal supplied by controller 26 may include a 3.3 volt, Manchester encoded digital signal having a frequency of approximately 1 MHz. Frequencies of 10 MHz and above may also be appropriate.

In certain embodiments, controller 26 may be associated with one or more processing devices. For example, a processor 28 and/or a processor 30 may be included in data sending unit 12. The additional processors may be included to precondition the signals applied to controller 26, to aid controller 26 in the performance of various processing tasks, and/or to perform any other appropriate functions.

Data sending unit 12 may include various other devices (not shown) that support the function of controller 26 or other components included in data sending unit 12. For example, data sending unit 12 may include one or more power sources, canard deployment mechanisms, data connection interfaces (DCI), power switching elements, power activation devices, power conditioning devices, squib firing circuits, motors, and motor control devices.

The information-carrying electrical signal provided by controller 26 may be supplied to a first capacitive element 32 of capacitive data link 18. In response to the information-carrying electrical signal applied to first capacitive element 32, a second capacitive element 34 associated with capacitive data link 18 may experience a change in charge. For example, an information-carrying electrical signal (e.g., V(t)) may be applied to first capacitive element 32. In response to the changing voltage of this signal, there will be a change in charge at second capacitive element 34 to oppose the changing voltage of the signal applied to first capacitive element 32. Thus, there may be a current passed by capacitive data link 18 that may be expressed as:
i=C(dv/dt)
where C is the capacitance of capacitive link 18, and (dv/dt) represents the rate of change in voltage over time of the information-carrying electrical signal applied to first capacitive element 32. This current signal mimics the information-carrying electrical signal applied to first capacitive element 32, albeit with a phase shift of −90 degrees. Thus, the current signal may represent another information-carrying electrical signal that is generated in response to the information-carrying electrical signal applied to first capacitive element 32. In this way, capacitive link 18 may effectively transmit data or information carried by the information-carrying electrical signal applied to first capacitive element 32 to circuitry or other components associated with second capacitive element 34.

In view of the capacitive nature of capacitive link 18, no physical contact is required between first capacitive element 32 and second capacitive element 34 in order to pass data from first capacitive element 32 to second capacitive element 34. Based on this characteristic, first capacitive element 32 and second capacitive element 34 may be configured to move relative to one another. That is, even when moving relative to one another, a capacitance can be maintained between first capacitive element 32 and second capacitive element 34. Therefore, data can be transferred through capacitive data link 18 despite relative motion between first capacitive element 32 and second capacitive element 34.

A signal conditioning unit 36 may be configured to receive the information-carrying electrical signal generated on second capacitive element 34.

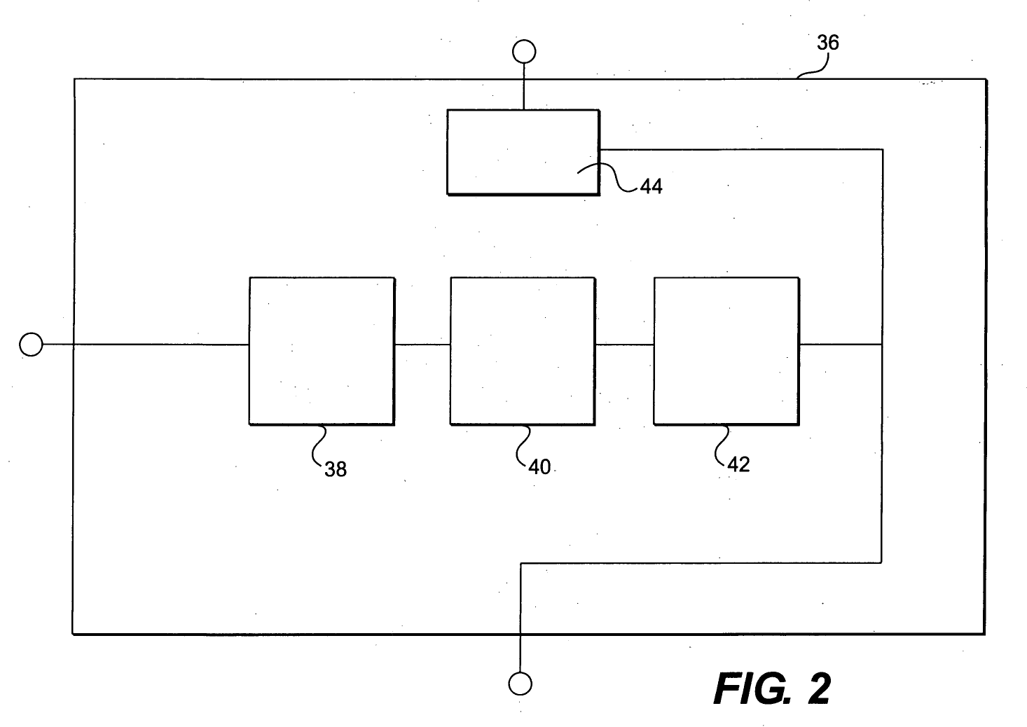

Signal conditioning unit 36 may include one or more electrical circuit components or modules configured to condition an electrical signal. In one embodiment, as shown in FIG. 2, signal conditioning unit 36 may include a charge amplifier 38, an amplifier 40, and/or a comparator 42 to condition the information-carrying electrical signal generated on second capacitive element 34. Signal conditioning unit 36 may also include transmission circuitry 44 configured to transmit the information-carrying electrical signal generated on second capacitive element 34 (or at least a conditioned version of that signal) to a location remote from data receiving unit 14. This signal may be transmitted using antenna 46, for example. While transmission circuitry 44 and antenna 46 may operate to transmit the conditioned signal in the form of a radio frequency (RF) signal, various other transmission technologies may be employed. For example, optical and/or acoustic devices may be used to transmit information contained in the conditioned signal.

The conditioned signal supplied by signal conditioning unit 36 may be supplied or used by various other components associated with data receiving unit 14. For example, the conditioned signal may be applied to a processing device 48. Further, various data associated with the conditioned signal may be stored in a memory 50, for example.

First capacitive element 32 and second capacitive element 34 may be arranged in a variety of configurations that allow relative motion between first capacitive element 32 and second capacitive element 34. In one embodiment, as illustrated in FIG. 1, first capacitive element 32 and second capacitive element 34 may be operatively coupled to housings or other components associated with data sending unit 12 and data receiving unit 14, respectively. Thus, relative motion of data sending unit 12 with respect to data receiving unit 14 results in relative motion between first capacitive element 32 and second capacitive element 34. In this embodiment, the relative motion between data sending unit 12 and data receiving unit 14 may be enabled by bearing 16 or any other type of motion-enabling coupling device or devices. It should be noted, however, that the relative motion between data sending unit 12 and data receiving unit 14 may also be accomplished without any physical coupling between these units. For example, in certain embodiments, data sending unit 12 and data receiving unit 14 may be part of a larger system configured to place data sending unit 12 and data receiving unit 14, and, therefore, first capacitive element 32 and second capacitive element 34, adjacent to one another without a physical connection between them.

Alternatively, data sending unit 12 may be fixedly coupled to data receiving unit 14. In this embodiment, relative motion between first capacitive element 32 and second capacitive element 34 may be achieved, for example, by configuring either of these capacitive elements to move with respect to data sending unit 12 or data receiving unit 14.

While not essential, first capacitive element 32 may be arranged substantially parallel to second capacitive element 34. Further, the capacitance provided by capacitive link 18 between first capacitive element 32 and second capacitive element 34 may remain substantially constant while second capacitive element 34 moves relative to first capacitive element 32. Because the capacitance of two spaced apart plates depends on the distance between the plates, the distance between first capacitive element 32 and second capacitive element 34 may remain substantially constant during relative motion between these elements. For purposes of this disclosure, a substantially constant capacitance includes at least those capacitance values falling within ±10% of an average capacitance value between first capacitive element 32 and second capacitive element 34. In one embodiment, first capacitive element 32 and second capacitive element 34 may be configured to provide a capacitance of at least 5×10⁻¹⁴ farads.

The spacing between first capacitive element 32 and second capacitive element 34 may be selected to provide a desired capacitance level. In one embodiment, first capacitive element 32 may be spaced apart from second capacitive element 34 by a separation distance of between about 0.025 inches and about 0.5 inches. The space between first capacitive element 32 and second capacitive element 34 may include a dielectric material and/or air.

Capacitive data link 18 may be configured for use with many types of relative motion between first capacitive element 32 and second capacitive element 34. For example, first capacitive element 32 and second capacitive element 34 may be configured to rotate and/or slide with respect to one another. Regardless, of what type of motion is selected, the distance between first capacitive element 32 and second capacitive element 34 should remain within a range that provides a substantially constant capacitance, as discussed above. First capacitive element 32 and second capacitive element 34 may be configured to move continuously with respect to one another. That is, in the case of a rotation motion component, first capacitive element 32 may be configured to rotate over one or more 360 degree rotation cycles (e.g., through a rotation angle of at least 360 degrees). Similarly, with respect to a sliding motion component, the continuous motion may result in one or more complete sliding cycles (e.g., through a sliding angle of at least 360 degrees in a cyclical wave representation).

First capacitive element 32 and second capacitive element 34 may be fabricated using any suitable electrically conductive material. For example, each of the capacitive elements may include copper, aluminum, iron, brass, nickel, any combination of these materials, any alloys including these materials, or any other suitable electrically conductive material.

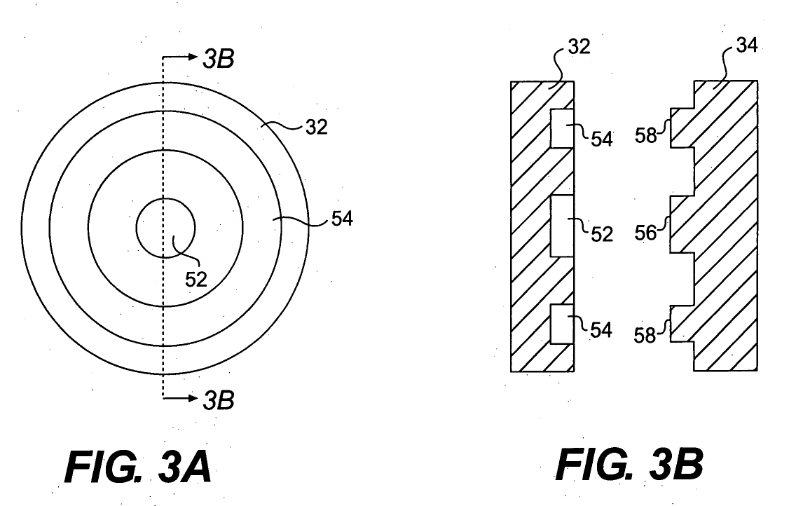

First capacitive element 32 and second capacitive element 34 may be shaped in a variety of ways. For example, both may include flat, electrically conductive plates. These plates may be round, square, rectangular, or any other suitable shape. Alternatively, as shown in FIGS. 3A and 3B, first capacitive element 32 and second capacitive element 34 may include one or more corresponding relief features.

FIG. 3A provides a top view of first capacitive element 32. As illustrated, first capacitive element 32 may include a cylindrical recess 52 and a ring-shaped recess 54. FIG. 3B provides a cross-sectional view of first capacitive element 32 and second capacitive element 34. As shown in FIG. 3B, second capacitive element 34 may include one or more protrusions corresponding to the recesses formed on first capacitive element 52. For example, second capacitive element 34 may include a cylindrical protrusion 56 configured to mate with cylindrical recess 52. Additionally, second capacitive element 34 may include protrusions 58 arranged to mate with ring-shaped recess 54. Protrusions 58 may be configured as a plurality of individual islands arranged in a ring pattern on second capacitive element 34. Alternatively, protrusions 58 may form a continuous ridge extending in a ring-shaped pattern on second capacitive element 34. It should be noted that first capacitive element 12 and second capacitive element 13 both may include any combination of recessed features and protrusions.

Capacitive data link 18 may be used in any system where there may be a desire to transfer information, in the form of an information-carrying electrical signal, from one location to a second location that moves with respect to the first location. As described above, capacitive link 18 can provide an arrangement for efficiently transferring information between two points in relative motion. Further, in view of the reactive load of the capacitor provided by capacitive data link 18, data sending unit 12 may operate at low (e.g., near zero) power levels. Similarly, the power requirements data receiving unit 14 are also low. Particularly, an exemplary configuration may require only a few milliamps or less of current to power the components associated with signal conditioning unit 36 and other components associated with data receiving unit 14.

It will be apparent to those skilled in the art that various modifications and variations can be made in the disclosed capacitive data link systems and methods without departing from the scope of the disclosure. Other embodiments of the disclosed systems and methods for tracking entities will be apparent to those skilled in the art from consideration of the specification and practice of the disclosure disclosed herein.

What is claimed is:

1. A capacitive data link comprising:
a first capacitive element;
a signal producing entity operatively coupled to the first capacitive element and configured to apply an information-carrying electrical signal to the first capacitive element; and
a second capacitive element spaced apart from the first capacitive element and configured to experience a change in charge in response to the information-carrying electrical signal applied to the first capacitive element,
wherein the first capacitive element and the second capacitive element are configured to move relative to one another.

2. The capacitive data link of claim 1, wherein the first capacitive element and the second capacitive element are configured to rotate relative to one another.

3. The capacitive data link of claim 1, wherein the change in charge experienced by the second capacitive element represents another information-carrying electrical signal, which has a phase different from the information-carrying electrical signal applied to the first capacitive element, and
further including one or more circuit components configured to condition the another information-carrying electrical signal.

4. The capacitive data link of claim 3, further including a transmitter to transmit the another electrical information-carrying signal.

5. The capacitive data link of claim 1, wherein the first capacitive element includes a recessed area, and the second capacitive element includes at least one protrusion configured to extend at least partially into the recessed area of the first capacitive element.

6. The capacitive data link of claim 5, wherein the recessed area and the at least one protrusion are arranged in a ring pattern on the first capacitive element and the second capacitive element, respectively.

7. The capacitive data link of claim 1, wherein at least a portion of the information-carrying electrical signal is encoded using one or more of frequency shift keying, non-return-to-zero, Manchester encoding, and phase shift keying.

8. The capacitive data link of claim 1, wherein the first capacitive element and the second capacitive element are spaced apart by a separation distance of between about 0.025 inches to about 0.5 inches.

9. The capacitive data link of claim 1, wherein the first capacitive element and the second capacitive element provide a predetermined capacitance value that remains substantially constant while the first capacitive element moves with respect to the second capacitive element.

10. A method of transferring data from a first component to a second component configured to move relative to the first component, comprising:
generating a first information-carrying electrical signal;
applying the first information-carrying electrical signal to a first capacitive element coupled to the first component;
observing a change in charge on a second capacitive element coupled to the second component and spaced apart from the first capacitive element; and
generating a second information-carrying electrical signal based on the change in charge observed on the second capacitive element.

11. The method of claim 10, further including transmitting the second information-carrying electrical signal to a location remote from the first and second components.

12. The method of claim 10, further including encoding the first information-carrying electrical signal using one or more of frequency shift keying, non-return-to-zero, Manchester encoding, and phase shift keying.

13. A data transmission system, comprising:
a first component;
a second component configured to move relative to the first component;
at least one electronic device operatively coupled to the first component and configured to generate an information-carrying electrical signal;
a first capacitive element operatively coupled to the first component and configured to receive the information-carrying electrical signal;
a second capacitive element operatively coupled to the second component such that the second capacitive element can move relative to the first capacitive element, the second capacitive element being spaced apart from the first capacitive element and configured to experience a change in charge in response to the information-carrying electrical signal received by the first capacitive element.

14. The data transmission system of claim 13, wherein at least a portion of the information-carrying electrical signal is encoded using one or more of frequency shift keying, non-return-to-zero, Manchester encoding, and phase shift keying.

15. The data transmission system of claim 13, further including a separation distance between the first capacitive element and the second capacitive element of between about 0.025 inches and about 0.5 inches.

16. The data transmission system of claim 13, wherein the information-carrying electrical signal includes information provided by one or more sensors associated with the data transmission system.

17. The data transmission system of claim 13, wherein the information-carrying electrical signal includes information provided by one or more processor devices associated with the data transmission system.

18. The data transmission system of claim 13, wherein the second component configured to rotate with respect to the first component.

19. The data transmission system of claim 18, wherein the second component is configured to rotate through an angle of 360 degrees or more with respect to the first component.

20. The data transmission system of claim 13, wherein the change in charge experienced by the second capacitive element results in another information-carrying electrical signal, and
the second component further includes a transmitter configured to transmit the another information-carrying electrical signal or a signal generated in response to the another information-carrying electrical signal to a location remote from the data transmission system.
